(19) United States
(12) Patent Application Publication
(10) Pub. No.: US 2025/0096491 A1
(43) Pub. Date: Mar. 20, 2025

(54) BATTERY TERMINAL AND DEVICE INCLUDING A BATTERY POLE AND A BATTERY TERMINAL

(71) Applicant: WAGO Verwaltungsgesellschaft mbH, Minden (DE)

(72) Inventors: Fabian WENIG, Artern (DE); Franziska SCHUETZE, Artern (DE)

(73) Assignee: WAGO Verwaltungsgesellschaft mbH, Minden (DE)

(21) Appl. No.: 18/889,367

(22) Filed: Sep. 18, 2024

(30) Foreign Application Priority Data
Sep. 20, 2023 (DE) 20 2023 105 481.1

(51) Int. Cl. H01R 11/28

(52) U.S. Cl. CPC H01R 11/282

(57) ABSTRACT

A battery terminal and device for connecting an electrical line to a battery pole of a battery are provided. The battery terminal has at least one line connector to connect the electrical line. At least one clamping sleeve is electrically connected to the line connector, which includes at least two clamping jaws separated from each other by a free space. At least one wedge-shaped spreading body and/or a pressing body formed with a V-shaped groove, the spreading body being adapted to move in a free space formed between the clamping jaws, due to the pivoting movement of an actuating lever. The clamping jaws being adapted to be spread apart hereby, and/or the clamping jaws being adapted to be encompassed by the pressing body from an outside and pressed together, due to the pivoting movement of the actuating lever.

This nonprovisional application claims priority under 35 U.S.C. § 119 (a) to German Patent Application No. 20 2023 105 481.1, which was filed in Germany on Sep. 20, 2023, and which is herein incorporated by reference.

### BACKGROUND OF THE INVENTION

### Field of the Invention

The invention relates to a battery terminal for connecting an electrical line to a battery pole of a battery. The invention also relates to a device, which includes a battery pole of a battery and a battery terminal of this type.

### Description of the Background Art

A battery terminal is known, for example, from EP 1 852 942 B1 or FR 2 881 582 A1.

### SUMMARY OF THE INVENTION

It is therefore an object of the invention to provide an improved battery terminal and a device formed therewith.

This object is achieved, in an example, by a battery terminal for connecting an electrical line to a battery pole of a battery, the battery terminal having the following features: at least one line connecting device for connecting the electrical line; at least one clamping sleeve electrically connected to the line connecting device, which has at least two clamping jaws separated from each other by a free space; at least one pivotable actuating lever; at least one wedge-shaped spreading body and/or a pressing body formed with a V-shaped groove; the spreading body being able to move in the free space between the clamping jaws, due to the pivoting movement of the actuating lever, and the clamping jaws being able to be spread apart hereby, and/or the clamping jaws being able to be encompassed by the pressing body from the outside and pressed together, due to the pivoting movement of the actuating lever.

A battery terminal of this type may be advantageously mounted on the battery pole without a great application of force. An easy and haptically pleasant operation of the battery terminal by the user is made possible by an actuating lever of this type. By carrying out a pivoting movement of the actuating lever, the battery terminal may be ergonomically and effortlessly fixed in place on the battery pole with the aid of its clamping sleeve, in that the clamping jaws are clamped in place on the battery pole under pretension. By generating the contact force to the battery pole only when the battery terminal is being mounted, a wear on the contact surfaces during the mounting process may be avoided. A cost-intensive coating of the contact surfaces on the battery pole and/or on the battery terminal, e.g., using a noble metal, is therefore not necessary. In addition, higher contact forces may be reached, so that the positioning of the battery terminal on the battery pole may also be ensured solely by means of friction force. In this way, an additional rotation prevention and/or latching with the battery pole may be dispensed with.

As a whole, the battery terminal according to the invention is characterized by an easy, intuitive handling for the user as well as a simple structural design, which, in turn, permits a cost-effective manufacturing.

The free space between the clamping jaws may be designed, for example, as a slit. The clamping jaws may have an inner contour facing the battery pole, which is adapted to the outer contour of the battery pole, for example, a circle section-shaped inner cross-sectional contour in the case of a cylindrical battery pole. The clamping sleeve may be configured to receive a battery pole having a predefined diameter, which may be defined, for example, in a specification of the battery terminal.

Depending on the design of the battery terminal including the spreading body or the pressing body, the clamping jaws may have a shorter distance from each other in the relaxed state than the predefined diameter of the battery pole, the same distance, or a greater distance in a section configured for receiving the battery pole. The clamping jaws may be elastically spread apart by the spreading body, i.e., their distance from each other is increased. If the spreading body is returned to a neutral position again, the clamping jaws spring toward each other and clamp the battery pole in place between themselves, due to their intrinsic clamping force. To increase the clamping force, a surrounding spring may also be mounted on the arrangement to increase the contact force to the battery pole. The clamping jaws may be pressed together by the pressing body to clamp it in place on the battery pole, i.e., their distance from each other is reduced. The pressing body has, for example, a groove which is provided with a conically tapering design. The groove is preferably designed to be V-shaped, at least in sections.

The line connecting device can be used to connect the electrical line, e.g. a battery cable, to the battery terminal. The line connecting device may be designed, for example, as a crimp sleeve, spring-force clamping connection, or screw clamping connection.

The battery terminal can include an insulating housing, which surrounds the line connecting device and the clamping sleeve in an electrically insulating manner. The danger of short circuits at the battery is reduced hereby. Both the battery and the battery terminal are protected hereby. A protection against contact is also given for the user.

The actuating lever can be pivotably mounted in the insulating housing via at least one bearing element. The actuating lever can be arranged largely within the housing hereby and is therefore protected by the insulating housing against damage. The actuating mechanism, i.e., the spreading body and/or the pressing body, may also be arranged in the insulating housing.

The actuating lever may be pivotable, in particular, around a pivot axis. The pivot axis may be defined, for example, by the at least one bearing element. The wedge-shaped spreading body may be rotatably mounted, for example, rotatably mounted around the pivot axis. The pressing body may be rotatably mounted, for example, rotatably mounted around the pivot axis. It is also possible that the wedge-shaped spreading body and/or the pressing body is/are displaceably mounted, for example, in a linearly displaceable manner.

The actuating lever can include an actuating arm for manual actuation, which protrudes out of the insulating housing. It permits an easy operation of the battery terminal. In addition, the actuating arm makes it possible to signal whether or not the battery terminal has already been clamped in place on the battery pole with the aid of its clamping sleeve.

The clamping jaws can be elastically resilient, so that they spring back again after a spreading apart effectuated by the actuation of the actuating lever or a pressing together after a return of the actuating lever. Such an elastically resilient functionality of the clamping jaws is, however, not absolutely necessary. For example, the necessary contact force when using the pressing body may be generated solely by the pressing body even without a spring action of the clamping jaws.

The clamping sleeve can be configured to receive a cylindrical battery pole. The insides of sections of the clamping jaws configured to receive the battery pole may therefore have a complementary shaping hereto, for example a circle section-shaped cross-sectional contour.

The spreading body can be arranged on the actuating lever or formed as a single piece therewith, and/or the pressing body is arranged on the actuating lever or formed as a single piece therewith. This permits the provision of a battery terminal which includes few components, so that the assembly is particularly easy. The manufacturing costs may also be minimized. For example, the actuating lever may be manufactured with the spreading body and/or pressing body as a metal component or as a plastic component, for example in an injection molding process.

The battery terminal can include a transfer element, which is movable with the aid of the actuating lever and is designed as a separate part from the actuating lever, the spreading body being arranged on the transfer element and or formed as a single piece therewith, and/or the pressing body being arranged on the transfer element or formed as a single piece therewith. A construction of this type may be, in particular, advantageously implemented with the aid of a pressing body which is formed separately from the actuating lever and is arranged on the transfer element or is formed as a single piece therewith.

The clamping sleeve can be formed from multiple lamellas layered to form a stack, each of which has its own separately spring-elastically deflectable clamping leg, the clamping jaws of the clamping sleeve being formed by the clamping legs of multiple or all lamellas. The electrical contacting of the battery pole may be further improved hereby. In addition, the axial removal preventor explained below may be easily implemented hereby for the battery terminal.

The clamping sleeve can be configured to receive a battery pole having a predefined diameter, the clamping legs of at least one lamella having a smaller inner diameter from each other in the relaxed state than the predefined diameter of the battery pole in a section configured to receive the battery pole. The clamping legs of a lamella of this type are therefore subjected to a certain pretension on the outside of the battery pole when the battery terminal is connected to the battery pole.

The object mentioned at the outset is also achieved by a device, which includes a battery pole of a battery and a battery terminal of the type mentioned above, the battery terminal encompassing the battery pole with its clamping sleeve and being fastened in a clamping manner on the battery pole with the aid of the clamping jaws. The advantages explained above may also be implemented hereby.

The battery pole can have at least one radially circumferential groove, at least one radially inner projection of the clamping spring, in particular, at least one clamping leg of at least one lamella of the clamping sleeve, engaging with the radially circumferential groove. An axial removal preventor for the battery terminal may be particularly easily implemented in this way. Due to the fact that the projection of the clamping sleeve engages with the radially circumferential groove of the battery pole, the battery terminal may not be readily removed from the battery pole in the axial direction. The battery terminal is thus additionally fixed on the battery pole by a form fit. In the design of the clamping sleeve having multiple layered lamellas, for example, one of the lamellas, for example the lamella closest to the free end of the battery pole, may engage with the radially circumferential groove by means of its clamping legs.

The battery terminal according to the invention is also generally suitable as a connecting terminal for other applications, e.g., as a bolt clamp. The connecting terminal may also have a sliding element for actuation instead of the actuating lever.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIGS. 1 through 6 show an example of the invention;

FIGS. 7 through 10 show an example of the invention; and

FIGS. 11 through 12 show an example of the invention.

### DETAILED DESCRIPTION

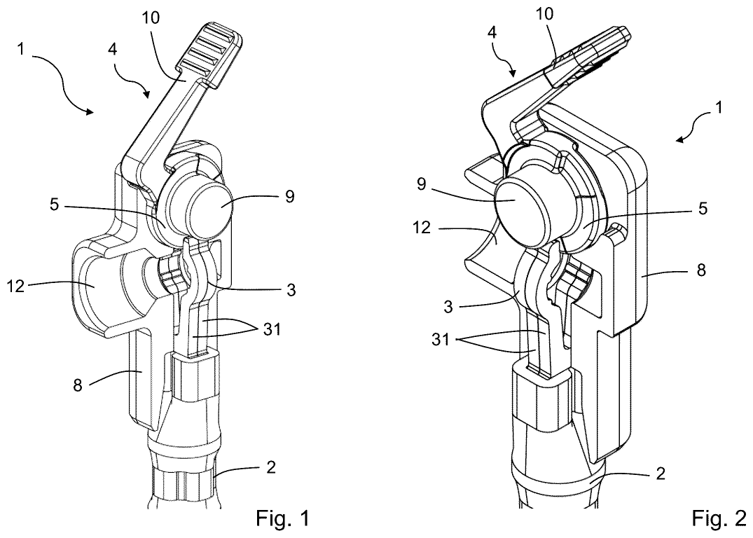

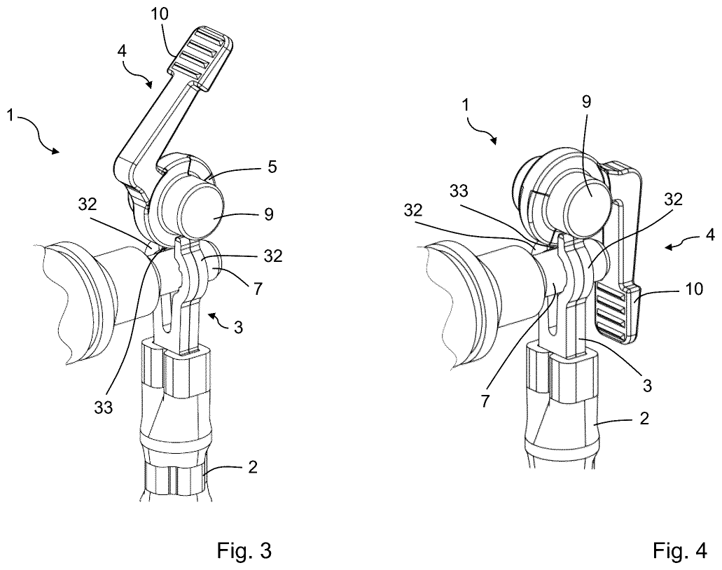

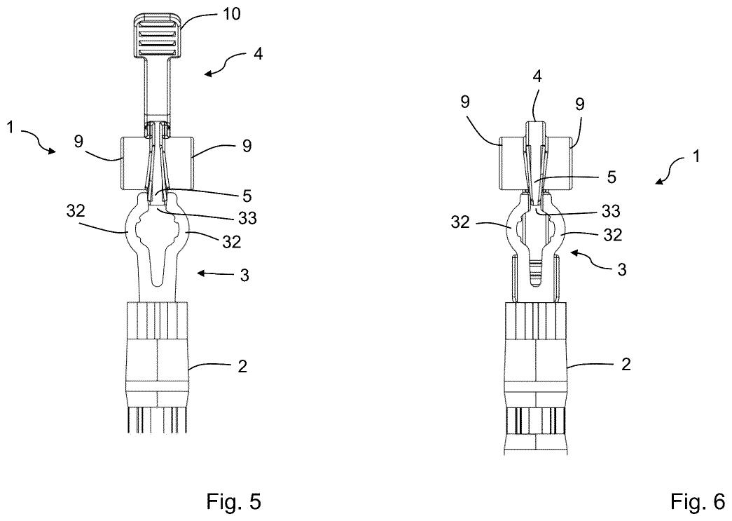

A battery terminal, which includes a wedge-shaped spreading body, is described in the first example according to FIGS. 1 through 6. FIGS. 1 and 2 show different perspective views of a battery terminal 1, including an opened insulating housing 8, FIGS. 3 and 4 show perspective views of battery terminal 1 without insulating housing 8, and FIGS. 5 and 6 show side views of battery terminal 1 without insulating housing 8. A battery pole 7 is additionally illustrated in FIGS. 3 and 4, so that these Figures also show a device which includes a battery pole 7 of a battery and a battery terminal 1.

In the first example, battery terminal 1 includes aforementioned insulating housing 8, a line connecting device 2 for connecting an electrical line, a clamping sleeve 3 connected to line connecting device 2, a pivotably mounted actuating lever 4, and a wedge-shaped spreading body 5. Wedge-shaped spreading body 5 is connected to actuating lever 4 or formed as a single piece therewith. Actuating lever 4 includes at least one bearing element 9, via which it is pivotably mounted, for example in insulating housing 8 and with the aid of one or two stub shafts protruding to the side. Actuating lever 4, including bearing element 9 and spreading body 5 as well as clamping sleeve 3, is at least predominantly situated within insulating housing 8. Line connecting device 2 protrudes from insulating housing 8. Actuating lever 4 protrudes from insulating housing 8 together with a manual actuating arm 10, which is configured to be actuated by the user. An insertion opening 12 for inserting battery pole 7 is present on insulating housing 8.

As is apparent, clamping sleeve 3 includes two clamping jaws 32, situated opposite each other, between which a free space 33 is formed. Wedge-shaped spreading body 5 protrudes into this free space 33 and, due to its wedge shape, may spread apart clamping jaws 32, i.e., press them away from each other, during a corresponding pivoting of actuating lever 4, so that free space 33 is enlarged, and battery pole 7 may be more easily inserted thereby into the intermediate space formed between clamping jaws 32. It is illustrated in FIGS. 3 and 5 that actuating lever 4 is pivoted in such a way that clamping jaws 32 are spread apart by wedge-shaped spreading body 5 so that battery pole 7 may be inserted into the intermediate space between clamping jaws 32 without an application of force.

FIGS. 4 and 6 show actuating lever 4 in a pivoting position, in which clamping jaws 32 are no longer spread apart by spreading body 5. Spreading body 5 is now loosely arranged in free space 33, i.e., a little play is present between spreading body 5 and the adjacent regions of clamping jaws 32. Clamping jaws 32 now spring toward each other again, due to their elasticity, and encompass battery pole 7 in a clamping manner, due to their spring pretension.

It is also apparent that clamping sleeve 3, including its clamping jaws 32, may be formed from multiple lamellas 31 layered to form a stack, two lamellas 31 in this case, lamellas 31 each having their own separately spring-elastically deflectable clamping legs, which form clamping jaws 32. However, it is also possible to not form clamping jaws 32 in a layered manner, but instead form them from a continuous piece of material in the axial direction of the battery pole.

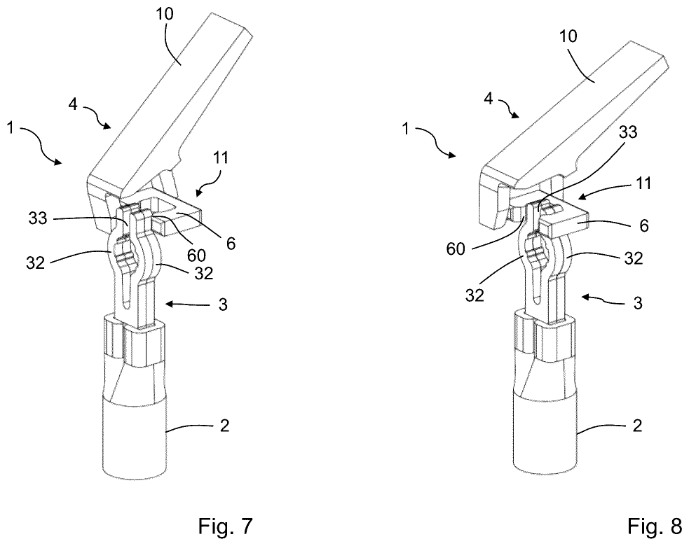

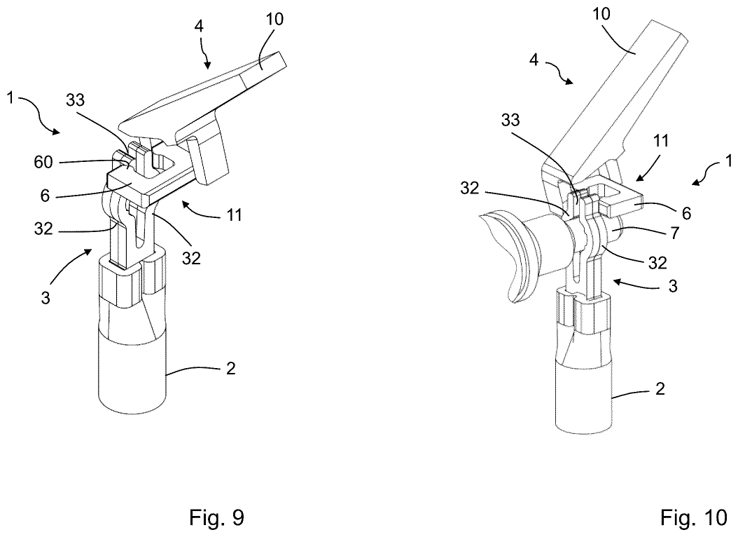

The second example, which is characterized by a design of the battery terminal including a pressing body 6, is described on the basis of FIG. 7 through 10. Instead of wedge-shaped spreading body 5, pressing body 6 is thus present, which has a V-shaped groove 60, by means of which clamping jaws 32 may be encompassed from the outside and pressed together. This reduces the size of free space 33 between clamping jaws 32.

FIGS. 7 through 10 shows battery terminal 1 in different perspective views, this example of battery terminal 1 also being able to have an insulating housing 8.

It is apparent that pressing body 6 is designed as part of a transfer element 11, which is designed as a separate component from actuating lever 4. Transfer element 11 may be pushed over actuating lever 4 relative to clamping jaws 32, as is shown, in particular, by a comparison of FIGS. 7 and 8. In FIG. 7, transfer element 11, including pressing body 6, has not yet been pushed over clamping jaws 32; in FIG. 8, pressing body 6 is pushed with transfer element 11 over clamping jaws 32. Due to the smaller internal spacing of the arms of pressing body 6 as a result of V-shaped groove 60, clamping jaws 32 are moved toward each other, and the size of free space 33 is thus reduced. In this state, battery terminal 1 may be clamped in place on battery pole 7.

The design with a separate transfer element 11 is also possible with the wedge-shaped spreading body. It is likewise possible to dispense with a separate transfer element 11 in the example with pressing body 6. For example, pressing body 6 may be formed as a single piece with actuating lever 4.

Battery terminal 1 may also include both actuating elements, i.e., wedge-shaped spreading body 5 and pressing body 6. In this case, the advantages of all examples may be combined with each other.

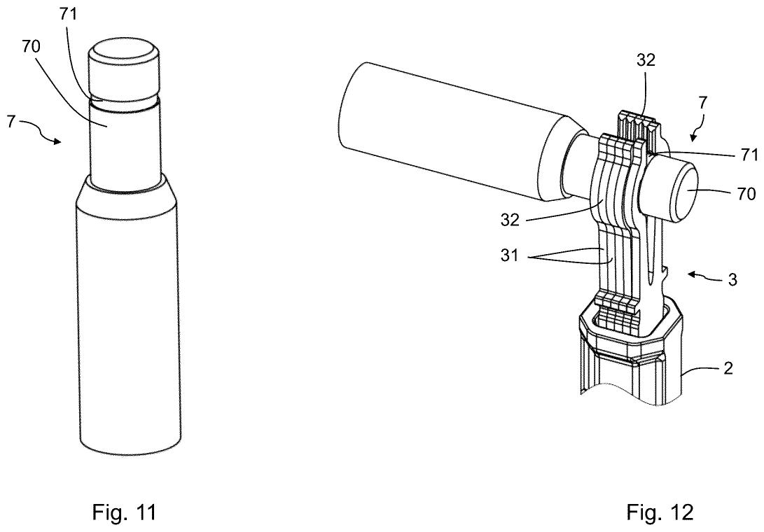

FIG. 11 shows, for example, a battery pole 7, which may be provided with a cylindrical design or may at least have a cylindrical connecting section 70. Battery pole 7 has a radially circumferential groove 71 in cylindrical connecting section 70.

FIG. 12 shows the connection of a battery terminal 1 to battery pole 7 illustrated in FIG. 11. In the example in FIG. 12, clamping sleeve 3 includes a multiplicity of individual lamellas 31, layered to form a stack, which each have separately spring-elastically deflectable clamping legs, which form clamping jaws 32 of clamping sleeve 3. The last lamella 31 oriented in the direction of the free end of connecting section 70 engages with groove 71 with the aid of its clamping legs and thereby fixes battery terminal 1 in the axial direction on battery pole 7 by means of a form fit. It is also conceivable that each of the other lamellas 31 or also all lamellas 31 of the stack of layered lamellas 31 engage(s) with groove 71. Battery terminal 1 may thus be readily removed from battery pole 7 in the axial direction, while it may also be rotated against battery pole 7.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A battery terminal to connect an electrical line to a battery pole of a battery, the battery terminal comprising:
at least one line connector to connect the electrical line;
at least one clamping sleeve electrically connected to the line connector, which includes at least two clamping jaws separated from each other by a free space;
at least one pivotable actuating lever; and
at least one wedge-shaped spreading body and/or a pressing body formed with a V-shaped groove, the spreading body being adapted to move in a free space formed between the clamping jaws, due to the pivoting movement of the actuating lever, and the clamping jaws being adapted to be spread apart hereby, and/or the clamping jaws being adapted to be encompassed by the pressing body from an outside and pressed together, due to the pivoting movement of the actuating lever.

2. The battery terminal according to claim 1, wherein the battery terminal includes an insulating housing, which surrounds the line connecting device and the clamping sleeve in an electrically insulating manner.

3. The battery terminal according to claim 2, wherein the actuating lever is pivotably mounted in the insulating housing via at least one bearing element.

4. The battery terminal according to claim 2, wherein the actuating lever includes an actuating arm for manual actuation, which protrudes from the insulating housing.

5. The battery terminal according to claim 1, wherein the clamping jaws are elastically resilient, so that they spring back again after a spreading apart effectuated by the actuation of the actuating lever or a pressing together after a return of the actuating lever.

6. The battery terminal according to claim 1, wherein the clamping sleeve is configured to receive a cylindrical battery pole.

7. The battery terminal according to claim 1, wherein the spreading body is arranged on the actuating lever or is formed as a single piece therewith, and/or wherein the pressing body is arranged on the actuating lever or is formed as a single piece therewith.

8. The battery terminal according to claim 1, wherein the battery terminal comprises a transfer element, which is movable with the aid of the actuating lever and is designed as a separate component from the actuating lever, wherein the spreading body is arranged on the transfer element or formed as a single piece therewith, and/or wherein the pressing body is arranged on the transfer element or formed as a single piece therewith.

9. The battery terminal according to claim 1, wherein the clamping sleeve is formed from multiple lamellas layered to form a stack, each of which has its own separately spring-elastically deflectable clamping legs, the clamping jaws of the clamping sleeve being formed by the clamping legs of multiple or all lamellas.

10. The battery terminal according to claim 9, wherein the clamping sleeve is configured to receive a battery pole having a predefined diameter, the clamping legs of at least one lamella having a smaller inner diameters from each other in the relaxed state than the predefined diameter of the battery pole in a section configured to receive the battery pole.

11. A device comprising:
a battery pole of a battery; and
the battery terminal according to claim 1,
wherein the battery terminal encompasses the battery pole with the clamping sleeve and is fastened on the battery pole in a clamping manner via the clamping jaws.

12. The device according to claim 11, wherein the battery pole has at least one radially circumferential groove, at least one radially inner projection of the clamping spring or at least one clamping leg of at least one lamella of the clamping sleeve engaging with the radially circumferential groove.
